(19) United States
(12) Patent Application Publication
(10) Pub. No.: US 2017/0278271 A1
(43) Pub. Date: Sep. 28, 2017

(54) IMAGING APPARATUS AND IMAGING METHOD

(71) Applicant: OLYMPUS CORPORATION, Tokyo (JP)

(72) Inventors: Osamu NONAKA, Sagamihara-shi (JP); Taichiro KOUCHI, Tokyo (JP)

(73) Assignee: OLYMPUS CORPORATION, Tokyo (JP)

(21) Appl. No.: 15/465,890

(22) Filed: Mar. 22, 2017

(30) Foreign Application Priority Data
Mar. 25, 2016 (JP) 2016-061598

(51) Int. Cl. G06T 7/00; H04N 5/907; H04N 7/18

(52) U.S. Cl. CPC G06T 7/97; H04N 7/183; H04N 5/907

(57) ABSTRACT

An imaging apparatus, comprising an imaging device that acquires a plurality of image data of a physical object, a measurement circuit that measures physical quantities of the physical object based on at least one item of image data among the plurality of image data, a controller that includes a condition changing section that changes imaging conditions of the imaging device, a representative image determination section that determines a representative image based on image data that has been selected from or combined with the plurality of items of image data, and a memory that stores measurement results from the measurement circuit and a representative image that has been determined by the representative image determination section.

Benefit is claimed, under 35 U.S.C. §119, to the filing date of prior Japanese Patent Application No. 2016-061598 filed on Mar. 25, 2016. This application is expressly incorporated herein by reference. The scope of the present invention is not limited to any requirements of the specific embodiments described in the application.

### BACKGROUND OF THE INVENTION

1. Field of the Invention

The present invention relates to an imaging apparatus and an imaging method that measure items such as physical quantities of a measured physical object based on image data that has been formed, and with which it is easy to manage such measurement data.

2. Description of the Related Art

Conventionally, a measurement device that performs imaging of a physical object using an imaging section, and measures physical quantities of the physical object using image data that has been acquired as a result of imaging, is known. For example, in Japanese patent laid-open number 2005-295818 (hereafter referred to as “patent publication 1”) there is disclosed a cell culture device that, when observing culture state of cells within a cell culture vessel, moves an imaging section having a narrow range of visual field on a culture vessel surface in advance, creates an image information location list based on information of culture vessel size, camera magnification factor and visual field range, and then images an arbitrary range within the cell culture vessel by moving the imaging section relative to the cell culture vessel

According to the cell culture device disclosed in patent publication 1, a movement range of the imaging section is determined in advance, and it becomes possible to measure a range that the user intends. However, after measurement has been completed, it is difficult to know intuitively at a later date what condition the measured physical object was in by simply looking at measurement results a few days later. Also, management such as searching etc. is also problematic, even if measurement results are retrieved. Also, this problem is not limited to cell culture devices, and similar drawbacks exist in cases where measurement is carried out based on image data that has been acquired by imaging.

### SUMMARY OF THE INVENTION

An object of the present invention is to provide an imaging apparatus and imaging method with which it can be intuitively grasped what a measured physical object is, and being excellent in terms of managing measurement results.

An imaging apparatus of a first aspect of the present invention comprises, an imaging device that acquires a plurality of image data of a single physical object, a measurement circuit that measures physical quantities of the physical object based on at least one item of image data among the plurality of image data. a controller that includes a condition changing section that changes imaging conditions of the imaging device, and a representative image determination section that determines a representative image based on image data that has been selected from or combined with the plurality of items of image data, and a memory that stores measurement results from the measurement circuit and a representative image that has been determined by the representative image determination section.

An imaging apparatus of a second aspect of the present invention comprises an imaging device that acquires a plurality of items of image data of a physical object, a measurement circuit that measures the physical object based on the image data, and a controller that includes a condition changing section that changes imaging conditions of the imaging device, and a representative image generating section that makes an image, that has been formed under predetermined conditions from among the plurality of image data that have been acquired by the imaging device, a representative image, and associates the representative image with measurement results from the measurement circuit.

An imaging method of a third aspect of the present invention comprises acquiring image data of a physical object while changing imaging conditions of an imaging device, carrying out measurement based on the image data and storing results of this measurement, and selecting and storing a representative image from the image data.

An imaging method of a fourth aspect of the present invention comprises acquiring image data of a physical object while changing imaging conditions of an imaging device, measuring the physical object based on a plurality of the image data that have been acquired while changing the imaging conditions, and making an image, that has been formed under predetermined conditions from among a plurality of image data that have been acquired by the imaging device, a representative image, and associating the representative image with the measurement results of the physical object.

### BRIEF DESCRIPTION OF THE DRAWINGS

FIG. 1 is a block diagram mainly showing the electrical structure of a camera of a first embodiment of the present invention.

FIG. 2 is a drawing showing an example of carrying out shooting using a camera of the first embodiment and measuring width of a pole.

FIG. 3A is a drawing showing a measurement image with the camera of the first embodiment, and FIG. 3B shows an example of a representative image.

FIG. 4 is a flowchart showing a measurement operation of the camera of the first embodiment.

FIG. 5 is a flowchart showing a modified example of a measurement operation of the camera of the first embodiment.

FIG. 6A is a drawing showing a measurement image with the camera of the first embodiment, and FIG. 6B shows another example of a representative image.

FIG. 7A is a perspective drawing showing usage state of an imaging system of a second embodiment, and FIG. 7B is a drawing showing an example of a representative image.

FIG. 8A and FIG. 8B are block diagrams mainly showing the electrical structure of an imaging system of the second embodiment.

FIG. 9 is a flowchart showing operation of an imaging section of the second embodiment.

FIG. 10 is a flowchart showing operation of an information terminal of the second embodiment.

### DETAILED DESCRIPTION OF THE PREFERRED EMBODIMENTS

An example where a digital camera (hereafter referred to as a camera) is adopted as a first embodiment of the present invention will be described in the following. This camera has an imaging section, and an image of a physical object is converted to image data by this imaging section. Using this image data serves a function as a commonly used camera. Also, this camera measures a physical quantity of the physical object based on image data that has been converted, and stores measurement results. The physical quantity is not limited to narrowly defined physical quantities such as mass, length, time, current flow, temperature, amount, luminosity etc. and is used having a wide meaning such as position, number, size, color etc. For example, there are widths and lengths that have been measured based on images, and test results of analyzing the widths and lengths for a respective image. If an image sensor is used that is capable of capturing distance data, distance, length and height, depth etc. also constitute physical quantities that are based on imaging results. Also, an image in which legibility of a physical object is high is made a representative image. When storing measurement results the results are stored associated with the representative image.

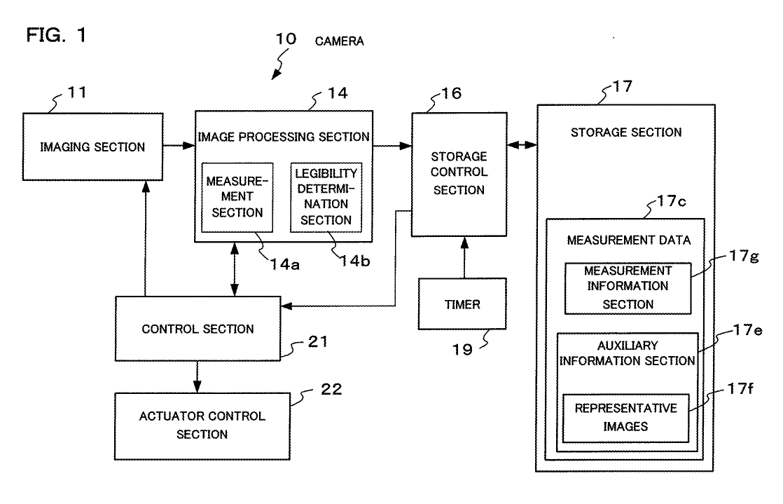

The camera 10 shown in FIG. 1 has an imaging section 11, image processing section 14, storage control section 16, storage section 17, timer 19, controller 21, and actuator control section 22.

The imaging section 11 has an image sensor for photoelectric conversion of an image, and has an optical lens for forming an image of a measured physical object and an imaging control circuit for reading out image signals that have been subjected to photoelectric conversion. Also, the imaging section 11 may have an aperture for light amount control, a mechanical shutter or an electronic shutter for exposure time control, and a focus lens for focus adjustment for focusing an image, etc. It should be noted that some of these members and circuits may be omitted as necessary, and other members and circuits may be added. The imaging section 11 functions as an imaging device for acquiring image data of a physical object. This imaging device also acquires a plurality of image data under a plurality of shooting conditions that have been changed by a condition changing section.

The image processing section 14 has an image processing circuit, and applies various common image processing to image data that has been output from the imaging section 11. For example, the image processing section 14 may perform various image processing such as optical black (OB) subtraction processing, white balance (WB) correction, demosaicing processing carried out in the case of Bayer data, color reproduction processing, gamma correction processing, color matrix computation, noise reduction (NR) processing, edge enhancement processing etc. on image data that has been output from the imaging section 11.

Also, the image processing section 14 may perform various image processing, such as edge enhancement and contrast adjustment on the image data of the measured physical object, so as to make measurement easy. A plurality of images may also be combined to give an image that is focused in the depth direction. Specifically, in a case where the imaging section 11 has a focus lens, a plurality of image data are acquired at different in-focus positions and then a combined image may be formed by stringing the in-focus positions of the acquired images together. In this way three-dimensional measuring becomes possible and it becomes possible to acquire physical quantity data in the depth direction, distance direction and rearward direction.

The image processing section 14 may also apply various image processing such as gradient adjustment and light and shade adjustment, and may also combine a plurality of images, so as to make an image easy to see as a representative image. In a case where a gradient sensor for gradient adjustment is provided, and an inclination is determined using the gradient sensor, height measurement is performed taking into consideration angle of elevation, and depth direction measurement becomes possible using angle of depression. There is also a use to determine latitude and longitude or an orientation relationship of a physical object in an image by using an orientation sensor and the position sensors in combination in an image.

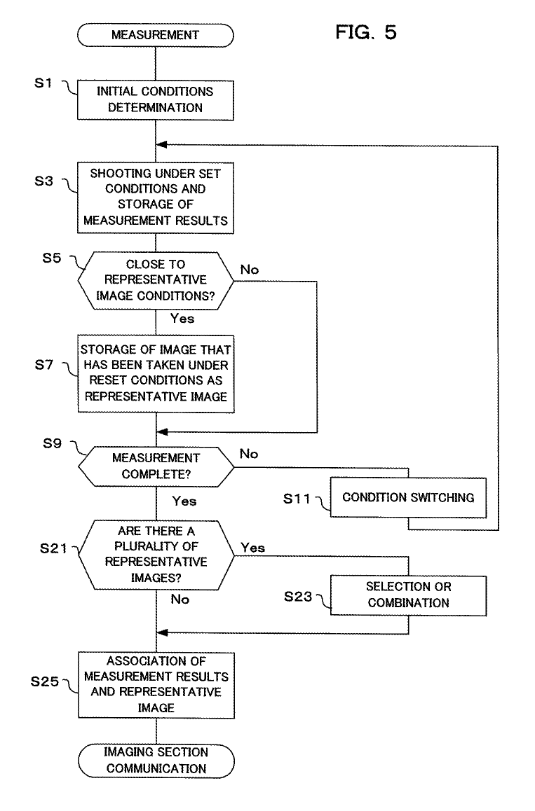

The image processing section 14 also carries out measurement of items such as number, size and position of a measured physical object using image data that has been subjected to various image processing. The image processing section 14 may also have a measurement section 14a that measures a physical object based on image data. Measurement by this measurement section is carried out based on at least one item of image data among a plurality of image data. This measurement is carried out based on a plurality of image data bats has been acquired while changing imaging conditions using the condition changing section (refer, for example, to S11 and S3 in FIG. 4). The image processing section 14 functions as an image processing section for applying image processing for measurement, to the image data that has been acquired by the imaging section, and the measurement section carries out measurement of a physical object using an image that has been subjected to image processing for measurement using this image processing section.

The image processing section 14 is also capable of selecting a representative image from among a plurality of images, or creating a representative image by subjecting a plurality of images to combination processing. The image processing section 14 functions as a representative image determination section, as part of a controller, that determines a representative image based on image data that has been selected from or combined with a plurality of items of image data. The image processing section 14 also functions as a representative image generating section, as part of a controller, that makes an image that has been formed under predetermined conditions, from among a plurality of image data that have been acquired by the imaging device, a representative image, and associates this representative image with measurement results from the measurement circuit (refer, for example, to S13 and S15 in FIG. 4). Representative image imaging conditions are set after completion of measurement by the measurement circuit, and this representative image generating section forms an image under these conditions (refer, for example, to S15 and S13 in FIG. 4).

The image processing section 14 may also have a legibility determination section 14b. This legibility determination section 14b carries out determination in order to determine shooting information conditions at which it is possible to capture an image with good legibility, in order to generate a representative image. As determination conditions for an image having good legibility there are, for example, images in which it is possible to observe the whole of a measurement object, images in which contrast of a measurement object is high, and images where color saturation etc. is high etc. It is also possible to determine that legibility is good in a case where a previous image and a current image are compared and there is change to a physical quantity etc. in a predetermined direction. As a shooting condition for taking an image with good legibility, for example, an instruction to switch an optical lens to the wide side, or the like, may be output. When determining legibility, adjustment may be made possible so that it is possible to reflect the preferences of the photographer in determination conditions. An image having good legibility should be an image in which, in a case of management, such as retrieving measurement data, a measured physical object is known at a glance when searching for intended measurement data.

The storage control section 16 has a storage control circuit, and controls storage of measurement results and representative images that have been output from the image processing section 14 to the storage section 17. The storage control section 16 is input with calendar information and time and date information etc. from the timer 19, and when storing measurement results and representative images may store such measurement results and representative images in association with the calendar information and time and date information etc.

The storage section 17 has a memory. As memory there may be electrically rewritable nonvolatile memory, there may be electrically rewritable volatile memory, or there may be both types of memory. A measurement data storage region 17c for storing measurement data is provided within the storage section 17, with respective regions of a measurement information section 17g and an auxiliary information section 17e being provided within the measurement data storage region 17c. Measurement results from the image processing section 14 are stored in the measurement information section 17g.

Also, the auxiliary information section 17e stores auxiliary information associated with information stored in the measurement information section 17g, such as, for example, calendar information, time and date information, and measurement position information for a measurement image. A storage region for representative images 17f that have been selected or created by the image processing section 14 is provided within the auxiliary information section 17e. The measurement information section 17g and the auxiliary information section 17e (including the representative images 17f) are stored in association.

The storage section 17 functions as a memory for storing measurement results from the measurement section and representative images that have been determined by the representative image determination section. Measurement results and representative images are stored in association.

The actuator control section 22 controls drive of actuators for the aperture, shutter, and focus lens etc. within the imaging section 11 in accordance with commands from the controller 21. For example, in the case where the actuator is for the aperture, control is performed so as to achieve an aperture value that has been instructed from the controller 21. Also, in the case when the actuator is for a shutter, shutter opening is controlled so as to achieve an instructed exposure time. In the case where the actuator is for a focus lens drive section, position of the focus lens is controlled so as to achieve an instructed focus position. This actuator control section 22 may be provided inside the camera 10 or may be provided outside the camera.

The controller 21 has a CPU (Central Processing Unit), peripheral circuits for the CPU, and an electrically rewritable nonvolatile memory storing programs, and executes control of the camera. Also, the controller 21 is input with storage state information (for example, the fact that storage processing for image data of a single frame has been carried out, etc.) from the storage control section 16, and instructs imaging conditions to the imaging section 11, image processing section 14 and actuator control section 22. This controller 21 changes imaging conditions of the imaging section 11, and carries out measurement using image data that has been captured under these imaging conditions that have been changed, and the controller for determining a representative image functions as a condition changing section as part of a controller for changing imaging conditions of the imaging section.

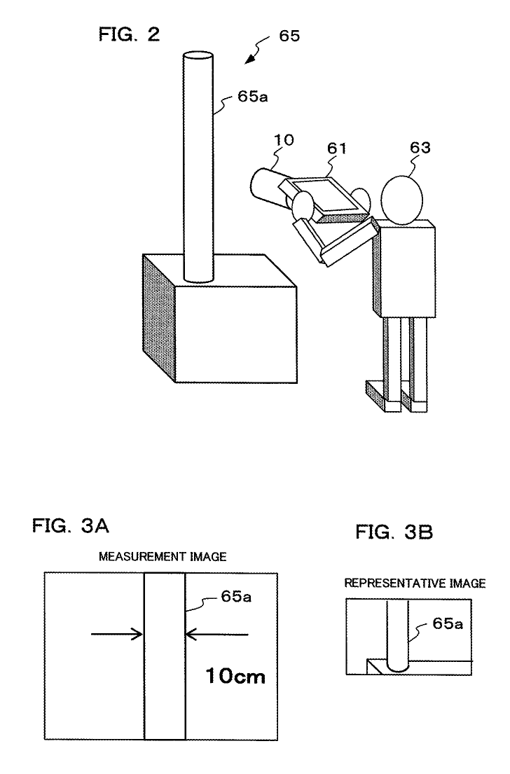

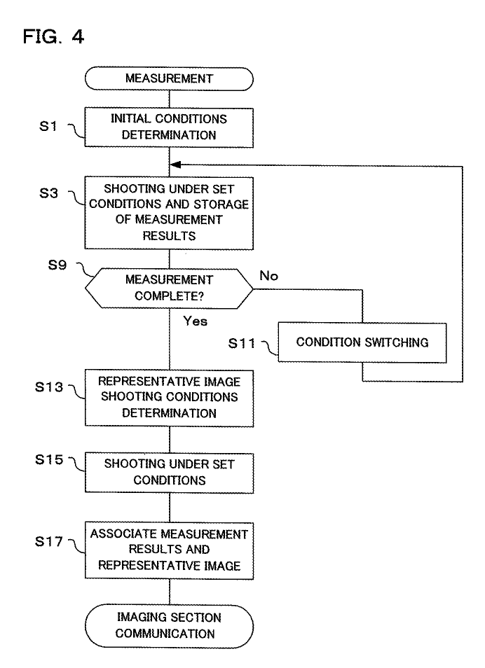

Next, measurement of a measured physical object and selection of a representative image with this embodiment will be described using FIG. 2, FIG. 3A and FIG. 3B. FIG. 2 shows appearance of a user 63 measuring width of a pole 65a of a measured physical object 65 using a camera 10. Image data of the measured physical object is acquired (captured) using the camera 10, the pole 65a of the measured physical object 65 is displayed on a display device 61 based on this image data, and width of the pole 65a (thickness of the pole) is measured based on the image data.

It should be noted that with this embodiment since the camera 10 does not have a display section, with the example shown in FIG. 2 the measured physical object 65 is displayed on a display of a display device 61 such as a smartphone. The camera 10 therefore has a communication section for transmitting image data externally, and acquiring instructions from an external display device such as a smart phone. In the event that the camera 10 has a display the measured physical object may be displayed on this display.

FIG. 3A shows a measurement image of the measured physical object. Since this shooting is carried out in order to measure width of the pole 65a, setting of shooting condition is carried out by the controller 21 so as to be optimum for measurement. Length on an image sensor can be easily obtained by applying image processing for contour enhancement to the image data. If length on the image sensor is known, it is possible to calculate width of the pole 65a using focal length at the time of shooting and distance to the pole 65a. Image data for measurement may be stored, but as long as measurement results are stored this is not absolutely necessary, and image data for measurement may not be stored.

FIG. 3B shows an example of a representative image stored in association with measurement results. While an image for measurement is an image that is suitable for measurement, it is a partial image, it is difficult to grasp the overall measured object, and image processing which is intended for measurement is applied so that there are many cases where the result is unsuitable for viewing. This results in a lack of swiftness due to it being difficult to understand when searching at a later date. With this embodiment therefore, a representative image is stored in association with the measurement results. This representative image is an image that has good legibility, and with which it is easy to intuitively grasp the whole of a measured physical object.

The representative image that was shown in FIG. 3B is an image taken looking from diagonally above so as to intuitively grasp the whole of the measured physical object 65, and taken in wide angle mode. The representative image may be stored at the actual image size, but if it is stored with the image size reduced it is possible to carry out retrieval rapidly at a later date. As information that is stored associatively in the storage section 17 there is this representative image, measurement results (with information of the road), measurement time information (based on output of the timer 19), and measurer information etc.

Next, measurement operation of this embodiment will be described using the flowchart shown in FIG. 4. This flow is executed by the CPU within the controller 21 controlling within the camera 10 in accordance with a program that has been stored in non-volatile memory.

If the flow for measurement is entered, first, initial conditions are determined (S1). With this embodiment, shooting is carried out a plurality of times while changing shooting conditions, and measurement is performed. In this step conditions for carrying out initial shooting are determined. As conditions, aperture value, shutter speed, focus position, focal length, shooting position, lighting conditions etc. are appropriately set based on subject brightness and focus conditions etc.

If initial conditions have been determined in step S1, next shooting is carried under the set conditions and measurement results are stored (S3). In the case of initial shooting the imaging section 11 carries out acquisition of image data under conditions that were set in step S1, and in the case of the second and subsequent shooting image data is acquired under conditions that have been switched to in step S11, which will be described later. If shooting is finished, the image processing section 14 applies image processing to the image data and calculates a measurement value for a given item (physical quantity). With the example shown in FIG. 2, FIG. 3A, and FIG. 3B width of the pole 65a is calculated. Once measurement results are obtained the storage control section 16 stores the measurement results in the measurement information section 17g. Also, at this time measurement time information and measurement information etc. may be stored in association.

If storage of measurement results has been carried out, it is next determined whether or not measurement is complete (S9). Determination as to whether or not measurement is complete may be made appropriately in accordance with characteristics of the measured physical object, such as, for example, a case where the user has stopped shooting by determining that measurement is complete and a case where measurement results having high reliability have been obtained, a case where a predetermined time has elapsed, a case where shooting under predetermined conditions has been completely finished etc.

If the result of determination in step S9 is that measurement is not complete, condition switching is carried out (S11). Conditions are changed gradually from the initial conditions of step S1 every time shooting is carried out. In this step the controller 21 sets a condition that has been changed slightly with respect to the previous condition. Once conditions have been switched processing returns to step S3 and shooting and measurement are carried out under the changed condition.

On the other hand, if the result of determination in step S9 is that measurement has been completed, next representative image shooting conditions are determined (S13). Here, as was described using FIG. 3B, conditions in order to capture an image so that a measured physical object is intuitively recognized are determined. As conditions, for example, aperture value, shutter speed, focus position, focal length, lighting conditions etc. may be determined. Conditions for the representative image may be stored beforehand in nonvolatile memory as default values, and may be changed in accordance with the user's preference.

If the representative image shooting conditions have been set, shooting is carried out under the set conditions (S15). Here, shooting is carried out under the representative image shooting conditions that were changed in step S13, the imaging section 11 acquires image data and the image data is output to the image processing section 14. The image processing section 14 may apply image processing for a representative image.

In the shooting of the representative image in step S15, shooting may be automatically carried out once there is conformity with shooting conditions that were set in step S13, and guidance display may be carried out on a display and advice may be given to the photographer so as to achieve the shooting conditions. It may also be made possible to change shooting conditions such that it is possible to reflect the user's preferences. Further, shooting is also not limited to a single time and it may also be made possible to carry out shooting a number of times while changing shooting conditions in a step-by-step manner, for example. In this case, for example, it may be made possible to change color and contrast or the like gradually.

If shooting has been carried out under set conditions, associating of measurement results and a representative image is carried out (S17). In this step, the measurement results of step S3 and the representative image that was captured in step S15 are associated with each other and stored in the measurement information section 17g and the representative image 17f of the storage section 17.

If association of the measurement results and the representative image has been carried out the flow for measurement is completed and imaging section communication is carried out. With imaging section communication, for example, measurement results and the representative image are transmitted to an external device.

In this way, in the first embodiment, measurement of a measured physical object is carried out based on image data, and measurement results and a representative image are associated with each other. The most appropriate measurement image for obtaining measurement results and the most appropriate representative image for understanding conditions at the time measurement was carried out are not necessarily the same. With this embodiment efforts are made to respectively acquire the respectively most appropriate image.

Also, in a device that analyzes images to carry out various examinations, diagnoses and measurements, if, instead of only storing as abstract data, an image that has been taken under conditions of good legibility is made a representative image and tagged with measurement conditions etc., management and visual retrieval performance are improved. A high visibility image can be shown to another person and explained even as evidence of accounts and reports.

Also, change of conditions at the time of measurement is change of focus position and angle of view, exposure, and lighting conditions, including wavelength and intensity, as well as change of shooting position and image processing for various enhancements and corrections. For example, an image that has been subjected to image processing to increase contrast for measurement etc. may be unnatural when made a representative image even if it is suitable for measurement.

Also, with this embodiment imaging conditions for the representative image are set after having carried out measurement, and an image for the representative image is acquired by imaging (refer to S9, S13 and S15 in FIG. 4). Since the time of shooting a representative image is after having carried out all of the shooting for measurement, it is possible to carry out shooting of the representative image under conditions that take into consideration all shooting conditions applied up to that point. It is therefore possible to acquire a representative image under the most appropriate conditions even in the event that a representative image is taken during shooting.

It should be noted that with this embodiment, the storage section 17 has been constructed integrally with the camera 10. However, this is not limiting, and it is also possible to provide a memory separately from the camera 10, and to store various information and data in an external storage section by means of a communication section. The sections besides the storage section may also be arranged externally, and connected by the communication section. Also, as was described previously, with this embodiment a display has been arranged externally to the camera 10, but the display may also be provided within the camera 10.

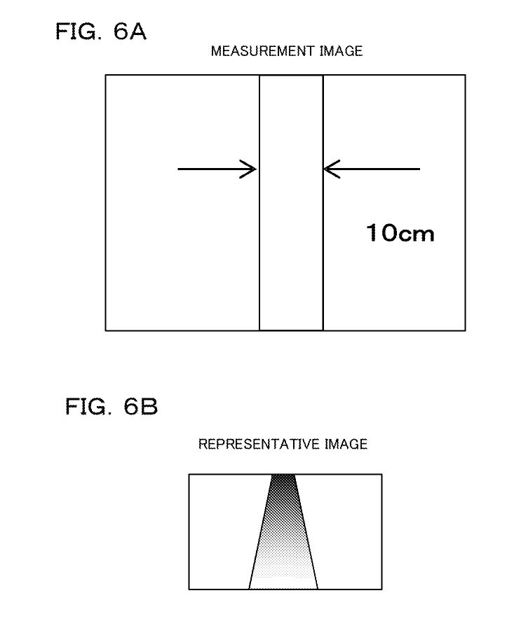

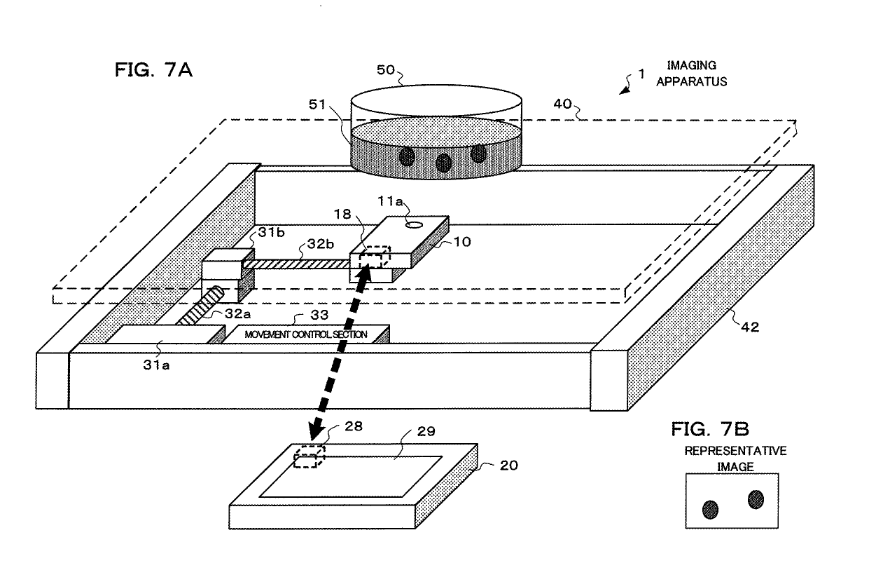

Next a modified example of the first embodiment will be described using FIG. 5, FIG. 6A and FIG. 6B. With the first embodiment shooting of a representative image was carried out after completion of measurement of the measured physical object. By contrast, with this modified example, when shooting an image for measurement, if the shooting conditions are close to conditions that are suitable for a representative image shooting is also carried out for a representative image (refer to S5 and S7 in FIG. 5).

Compared to the first embodiment, this modified example differs only in that the flowchart shown in FIG. 4 is change to the flowchart shown in FIG. 5, and the image shown in FIG. 3 is change to the image shown in FIG. 6. Other operation etc. is the same as for the first embodiment, and so detailed description of the same operations (including the steps in the flowchart shown in FIG. 5) is omitted.

If the flow for measurement shown in FIG. 5 is entered, initial conditions are set (S1), shooting is performed under the set conditions, and measurement results are stored (S3). Next it is determined whether shooting conditions are close to conditions for a representative image (S5). Here it is determined whether or not set conditions at the time shooting was performed in step S3 and set conditions that are suitable for shooting a representative image are close to each other. In order to determine whether or not a condition for shooting a representative image and this condition are close, a predetermined threshold value is determined.

If the result of determination in step S5 is that the shooting condition is close to the condition for a representative image, a shooting is carried out by resetting the condition as for a representative image, and the image is stored (S7). Here, conditions for a representative image that were used at the time of determination in step S5 are set again as conditions for shooting, and shooting is carried out using the imaging section 11. Once shooting has been carried out, image data is read out and temporary storage to a memory such as the storage section 17 is carried out.

If the image storage has been carried out in step S7, or if the result of determination in step S5 was that shooting conditions were not close to representative image conditions, it is determined whether or not measurement has been completed (S9), and in the event that measurement has not been completed conditions are switched (S11), processing returns to step S3, and shooting and measurement are carried out with conditions changed.

If the result of determination in step S9 is that measurement has been completed, it is next determined whether or not there are a plurality of representative images (S21). There may be situations where shooting of a representative image is carried out in step S7, and this shooting is carried out a number of times. Therefore, in this step S21 determination is based on whether or not shooting of a representative image has been carried out a number of times.

If the result of determination in step S21 is that there are a plurality of representative images, next selection or combination are carried out (S23). In this step, the legibility determination section 14b may select the most appropriate image from among the plurality of temporarily stored representative images, for example, as a representative image. Also, the image processing section 14 may form an image so as to be determined having high visibility by the legibility determination section 14b from the plurality of images.

If this selection or composition of a representative image has been carried out in step S23, or if the result of determination in step S21 is that there are not a plurality of representative images, next the measurement results and the representative image are associated (S25). Here, the storage control section 16 stores the measurement results of step S3 and the representative image that was selected or composed in steps S7 and S23 so as to be associated with each other. If the measurement flow is finished, next there is a transition to imaging section communication.

FIG. 6A shows a measurement image of the measured physical object of this modified example. The measurement image of this modified example is the same as the measurement image of the measured physical object that was shown in FIG. 3A, and so detailed description is omitted.

The representative image that was shown in FIG. 6B is an image that was selected from images that were acquired as representative images in step S7 by shooting a plurality times or an image resulting from combining a plurality of images. An example of this representative image appears as a skewed image because the camera is not horizontal at the time of shooting. With this modified example also, the size of image data that has been acquired is reduced. By making the image size small display is simplified, and rapid retrieval becomes possible. Also, with this modified example also, the representative image is stored in the storage section 17 in association with measurement results (width information of the rod), measurement time information (based on output of the timer 19), and measurer information etc.

In this way, with the modified example of the first embodiment, in the event that currently set shooting conditions are close to a condition for shooting a representative image when carrying out measurement of a physical object, it means that shooting of a representative image has being carried out (S5, S7). Specifically, in the event that shooting conditions when image data has been acquired are close to representative image conditions, a representative image is selected from within image data that has been acquired. This means that since it is possible to carry out shooting of the representative image between shooting of the measurement image, it is possible to shorten the shooting time.

It should be noted that while, with this embodiment, the image processing section 14, storage control section 16 and actuator control section 22 have been constructed separately from the controller 21, this is not limiting and some of these functions may be executed in software by the CPU within the controller 21. For example, the measurement section 14a and the legibility determination section 14b within the image processing section 14 may be executed by the CPU within the controller 21.

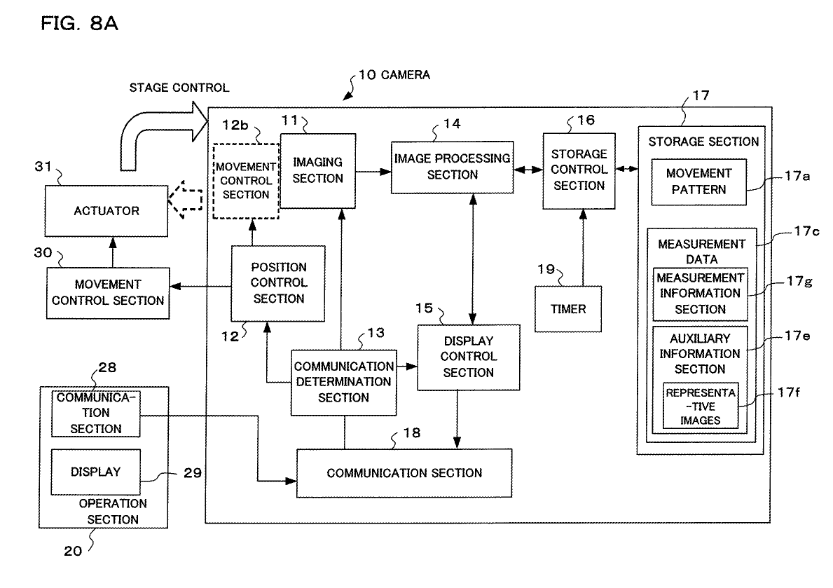

Next, a second embodiment will be described using FIG. 7A to FIG. 10. The first embodiment is an example where the present invention was applied to a digital camera. By contrast, the second embodiment is an example where the present invention has been applied to an imaging system having an imaging unit 1 and an operation section 20 arranged inside a constant temperature bath or incubator or the like (not illustrated) that maintains a steady environment.

The operation section (input device) 20 of this imaging system is arranged outside the incubator or the like. The imaging unit 1 captures an image of a specimen 51 cultivated in a container 50, and it is possible to measure physical quantities of the specimen 51 (for example, cells) from the captured image. As a result, with this embodiment valuable measurement and observation are carried out within the incubator or the like and it is possible to preserve the environment, which means that reliability is increased. Since observation within the incubator is carried out remotely, energy saving and highly reliable design are important.

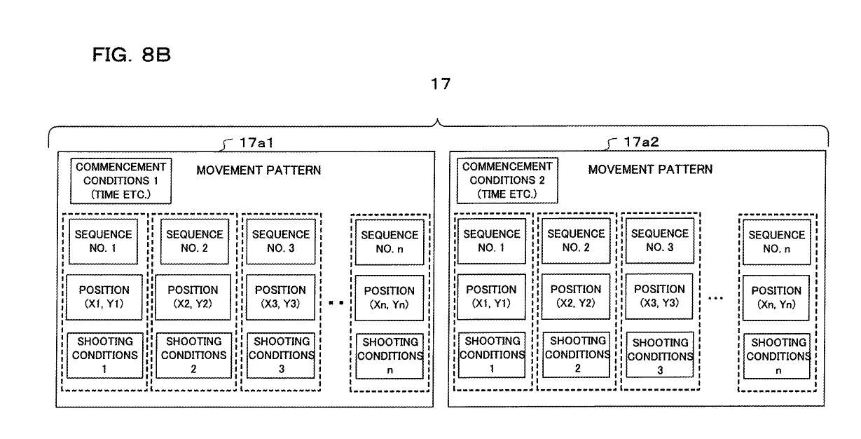

FIG. 7A is a perspective drawing showing the overall structure of the imaging system. The imaging unit 1 has a camera 10, Y actuator 31a, X actuator 31b, Y feed screw 32a, X feed screw 32b, movement control section 33, transparent plate 40, and housing 42. The camera 10 has a lens 11a, with an image that has been formed by the lens 11a being subjected to photoelectric conversion by an imaging section 11 (refer to FIG. 8A) to acquire image data. Also, a communication section 18 is also arranged inside the camera 10, and wireless communication is possible with a communication section 28 within an operation section 20 that is arranged externally to the imaging unit 1. The lens 11a may be a fixed focal length lens or may be a zoom lens, but is not limited. The detailed structure of the camera 10 will be described later using FIG. 8A and FIG. 8B.

The camera 10 is held on an X feed screw 32b, and is capable of moving in the X axis direction by rotating the X feed screw 32b. The X feed screw 32b is driven to rotate by the X actuator 31b. The X actuator 31b is held on the Y feed screw 32a, and is capable of movement in the Y axis direction by rotation of the Y feed screw 32a. The Y feed screw 32a is driven to rotate by the Y actuator 31a.

The movement control section 33 carries out drive control for the Y actuator 31a and the X actuator 31b, and performs drive control of the camera 10 in the X axis and Y axis directions in accordance with a procedure that has been preprogrammed. Also, in a case where the user has moved to the camera 10 to a particular position, since a manual operation is instructed by the operation section 20, the movement control section 33 moves the camera section 10 in accordance with the user's instruction.

It should be noted that although not illustrated in FIG. 7A a built-in power supply battery is provided within the imaging unit 1. Power is supplied to some or all of the movement control section 33, Y actuator 31a, X actuator 31b, and camera 10 by the built-in power supply battery. Also, communication lines are provided for communication of control signals in both directions between each of the sections. With this embodiment it is assumed that a power supply battery is used as the power supply but this is not limiting, and supply of power may also be implemented using an AC power supply. It is also assumed that control signals between each of the sections are interchanged by means of wired communication, but it is also possible to use wireless communication.

The above described camera 10, Y actuator 31a, X actuator 31b, Y feed screw 32a, X feed screw 32b, and movement control section 33 are arranged inside the transparent plate 40 and outer housing 42. The transparent plate 40 and housing 42 constitute an encapsulating structure such that moisture does not infiltrate into the inside from outside. As a result it is possible to suppress the occurrence of the inside of the transparent plate 40 and the housing 42 becoming high humidity, even if the inside of the incubator is high humidity.

It is possible to mount the container 50 on the upper side of the transparent plate 40, and it is possible to fill a culture medium into the inside of the container 50 and cultivate a specimen 51 (cells). The lens 11a of the camera 10 forms an image of the culture within the container 50, and by analyzing the image it is possible to measure a physical quantity of the specimen 51. For example, it is possible to count how many of the specimen 51 there are. Specifically, it is possible to count the specimen 51 within the container 50 while moving the camera 10 using the X actuator 31b and the Y actuator 31a.

The operation section 20 has a communication section 28, and can perform wireless communication with the communication section 18 inside the imaging unit 1. This means that it is possible for the operation section 20 to carry out communication with the camera 10 from a position that is remote from the imaging unit 1, and it is possible to move the camera 10 and to receive image data that has been acquired by the camera 10. It should be noted that the operation section 20 may be a dedicated unit, or an information terminal device such as a smartphone may also double as the operation section.

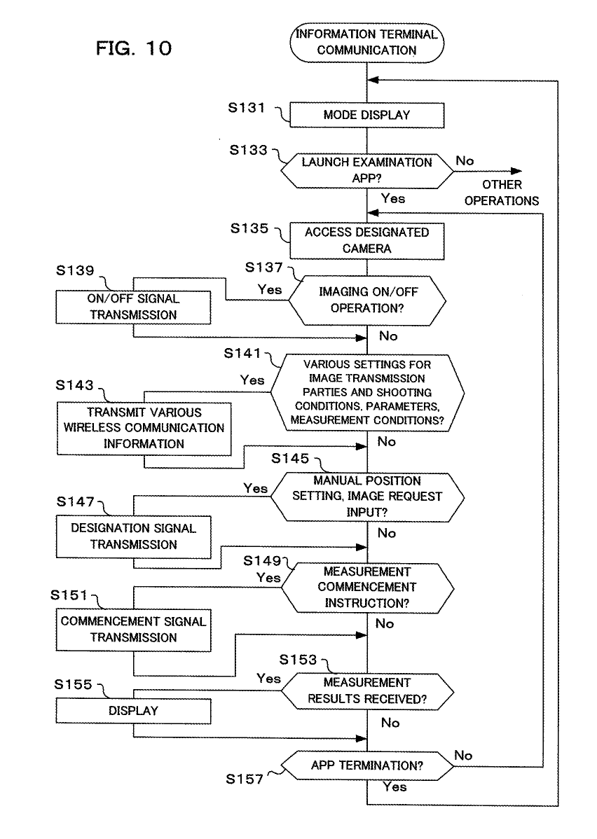

Also, the operation section 20 has a display 29, and the display 29 may carry out display of various modes of the operation section 20 and various setting icons (refer, for example, to S131 in FIG. 10). If a touch panel is provided, it is possible to carry out various inputs using a touch operation. Also, the display 29 may display images that have been acquired by the camera 10 and transmitted (refer to S155 in FIG. 10).

FIG. 7B shows an example of a representative image of this embodiment. This representative image is a reduced version of a captured raw image, and image data of this image is produced by reducing data size of raw data captured by the camera 10. As will be described later, with this embodiment a measurement object is, for example, a number of specimens (cells) 51 within a container 50. A representative image, coordinate information, measurement time information (time and date information), measurer information, and other information is stored as associated information with this number of the specimens 51.

It should be noted that as the representative image, as well as reducing the size of raw image data the representative image may also be an image depicting cells in some or all regions of the container 50 as a result of adjusting focal length, and may be an image depicting cells in some or all regions of the container 50 as a result combining a plurality of images. Also, since an image that has been taken at high magnification has a shallow depth of field, an image having a deeper depth of field may be generated as a representative image by combining a plurality of images that have been taken while varying focus.

Also, in a case where number of the specimens (cells) 51 is stored, an image when that number is greater than or less than a predetermined number may be made a representative image. For example, in a case where a number of cells at the time of commencing shooting is small, an image in which the number of cells is maximum may be the most distinctive image. Distinctive images often have high legibility. This means that by making a distinctive image a representative image a user can easily grasp the content of that image.

Also, in a case where number of the specimens (cells) 51 is stored, an image when an increase in number of specimens (cells) 51 in a given time is greater than or less than a predetermined number may be made a representative image. An increase speed or proliferation speed of the specimens (cells) 51 is not always constant. In a case where proliferation speed of the specimens (cells) 51 is high, it is possible, during measurement, to confirm that a distinctive reaction has occurred. In this point, the point in time at which the distinctive reaction occurred is a case of an image having high legibility, and can be made a representative image.

An image that has been taken a predetermined time after commencing shooting may also be made a representative image. In a case where a characteristic of the specimens (cells) 51 is known in advance, there may be cases where it is possible to predict a time when it is possible to acquire a distinctive image. In this case, by making an image that was taken at a time when it was possible to acquire a distinctive image a representative image, the user can easily grasp the content of that image.

Also, in the event that there is a specimen characteristic determination section that determines distinctive shapes, colors and sizes etc. of the specimens (cells) 51, if a characteristic that has been determined by the specimen characteristic determination section satisfies predetermined conditions an image that satisfies those conditions may be made a representative image. For example, if the specimens (cells) 51 form a colony, a time when the colony is a given size or greater is the case of a distinctive image. In this case, an image that has been taken when the specimen characteristic determination section determines the size of a colony and the colony is a given size or greater can be made a representative image.

Next, the electrical structure of the imaging system of this embodiment will mainly be described using FIG. 8A and FIG. 8B.

The imaging section 11 has an image sensor and an imaging control circuit etc., with an image that has been formed by the lens 11a being subjected to photoelectric conversion and image data output to the image processing section 14. The imaging section 11 may also have an exposure control section such as an aperture, mechanical shutter or electronic shutter, and may carry out control in accordance with an exposure control instruction from a communication determination section 13. As well as imaging, there is also an illumination section (not shown), and shooting, observation and aids to measurement may be carried out by illuminating the physical object. The imaging section 11 functions as an imaging device for acquiring image data of a physical object.

The image processing section 14 has an image processing circuit and a measurement circuit etc., and performs various image processing such as optical black (OB) subtraction processing, white balance (WB) correction, demosaicing processing carried out in the case of Bayer data, color reproduction processing, gamma correction processing, color matrix computation, noise reduction (NR) processing, edge enhancement processing etc. on image data that has been output from the imaging section 11. Image processing that places importance on legibility, and image processing for measurement that is appropriate to image determination of a physical object, are made possible. Lighting may also be switched to aid observation, as required.

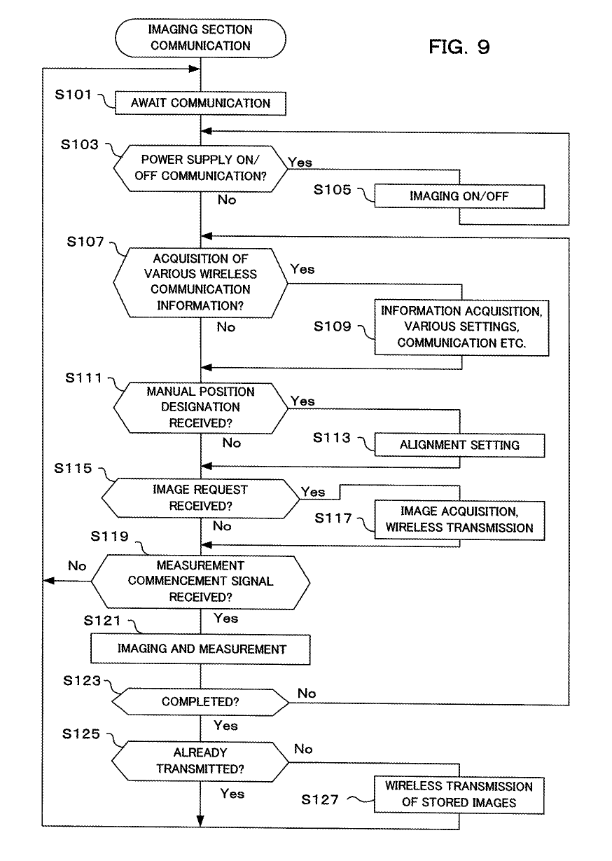

The image processing section 14 carries out measurement of a number of cells etc. The image processing section 14 functions as a measurement circuit for measuring physical quantity of a physical object based on image data (refer to S121 in FIG. 9). This measurement circuit carries out a measurement of a physical quantity of a physical object using an image that has been subjected to image processing for measurement by the image processing section. The image processing section 14 also functions as a representative image determination section, as part of a controller, that determines a representative image based on image data that has been selected from or combined with a plurality of items of image data (refer to S121 in FIG. 9).

The image processing section 14 also functions as a representative image generating section, as part of a controller, that makes an image that has been captured under conditions of good legibility, from among a plurality of image data that have been acquired by the imaging section, a representative image, and associates this representative image with measurement results from the measurement section (refer to S121 in FIG. 9). This representative image generating section stores an imaging condition in a case the image condition for performing measurement using the measurement section are close to imaging conditions for a representative image. The image processing section 14 also functions as an image processing circuit for applying image processing for measurement to the image data that has been acquired by the imaging section

The storage control section 16 has a storage control circuit, and carries out control in order to store image data that has been subjected to image processing by the image processing section 14 in the storage section 17. In storage control of the image data, coordinate information representing position of the camera 10 when shooting was carried out, and time and date information when shooting was carried out, may be attached to the image data as tag information. The storage control section 16 may also carry out readout control of movement pattern 17a, measurement data 17c and the auxiliary information section 17e that has be stored in the storage section 17. A timer 19 may also generate time and date information and output this information to the storage control section 16.

The storage section 17 is an electrically rewritable nonvolatile memory, and stores the previously described movement pattern 17a, measurement data 17c and auxiliary information section 17e. Within the storage section 17, the measurement data 17c, measurement information section 17g, auxiliary information section 17e and representative images 17f are the same as for the case of the first embodiment shown in FIG. 1, and so detailed description has been omitted.

The movement pattern 17a may record movement patterns that store commencement condition 1, sequence number, position, and shooting conditions for commencement of movement of the camera 10, such as shown by movement pattern 17a1, 17a2, . . . , as shown in FIG. 8B. These movement patterns 17a1, 17a2, . . . may be changed, in a manner of movement patterns 17a1, 17a21, 17a31, . . . , in accordance with change in conditions at the time of measurement. A plurality of movement patterns are stored in advance and may be automatically switched in accordance with conditions, patterns may be switched upon confirmation of the conditions by the user, or patterns may be altered by means of communication. As constituent elements of a pattern, in this embodiment there are time, shooting conditions, and shooting position (coordinates), but as well as these items information on a measured physical object etc. may also be included. There may be situations where a plurality of users perform observation using the same device, and so at that time it may be possible for a user to store information individually.

The storage section 17 functions as a memory for storing measurement results from the measurement section and representative images that have been determined by the representative image determination section.

As measurement data 17c stored in the storage section 17, in addition to measurement results of the measured physical object that were described in the first embodiment image data that has been acquired by the imaging section 11 is also included. Also, time and data and coordinate information is stored by having tags attached to individual image data. The storage section 17 stores image data that has been captured by the imaging section. Obviously, it is not always necessary to store imaging results and measurement results in the storage section 17, and these items of information may be externally transmitted by means of communication and stored in a storage section of an external device.

The communication section 18 has a communication circuit and interface circuit, an antenna in the case of wireless communication, or a cable in the case of wired communication etc., and carries out communication with the communication section 28 within the operation section 20, which is external to the imaging unit 1, as described earlier. The communication section 18 functions as a communication circuit for carrying out communication with an external terminal. This communication circuit also performs communication to carry out positioning and imaging control in accordance with position of the imaging device and imaging conditions that have been stored in memory, and performs communication of information that has been acquired by means of imaging using the imaging device (refer, for example, to S109, S113, S117 and S127 in FIG. 9).

Still further this communication circuit carries out communication of signals corresponding to image data (refer, for example, to S117 and S121 in FIG. 9) and signals for changing position of the imaging section using a position change section (refer, for example, to S109 and S111 in FIG. 9) with the external terminal. In the case of wired communication, supply of power to each of the sections may be carried out using a communication line. Supply of power to each of the sections may also be carried out in combination with a battery.

The communication determination section 13 determines content of communication from the operation section 20 that has been received by the communication section 18, and carries out control such as movement of the position of the camera 10 by the position control section 12, control of acquisition of image data by the imaging section 11, reading out of image data that has been stored in the storage section 17 by the display control section 15, and transmission to the operation section 20.

The communication determination section 13 carries out imaging using the imaging section (refer, for example, to S121 in FIG. 9) in accordance with shooting conditions, while moving position of the imaging section in accordance with a movement pattern (refer, for example, to the movement pattern 17a of the storage section 17), if an instruction to commence imaging using the imaging section, that is carried out based on control data, is received by means of the communication section (refer, for example, to S119 in FIG. 9).

The communication determination section 13 also transmits image data that has been stored in the storage section to an external terminal via the communication section (refer, for example, to S117 and S127 in FIG. 9) if imaging has been carried out by the imaging section (for example, S123 Yes in FIG. 9). The communication determination section 13 transmits image data to the external terminal (refer, for example, to S117 in FIG. 9) if an image data transmission request is received from the external terminal (refer, for example, to S115 in FIG. 9). The communication determination section 13 transmits image data to the external terminal by means of the communication section (refer, for example, to S127 in FIG. 9) if imaging by the imaging section has been completed for all of a plurality of movement patterns (refer, for example, to S123 Yes in FIG. 9). Here, it is not always necessary to transmit image data, and data such as measurement values and image characteristics that have been acquired from the image data may also be transmitted.

If a position has been designated manually from the external terminal by means of the communication section (refer, for example, to S111 in FIG. 9 and S147 in FIG. 10), the communication determination section 13 makes an imaging position change section move the imaging section to the designated position (refer, for example, to S113 in FIG. 9). The communication determination section 13 transmits image data to the external terminal via the communication section (refer, for example, to S117 in FIG. 9) if transmission of an image has been requested from the external terminal by means of the communication section (refer, for example, to S115 in FIG. 9 and S147 in FIG. 10). This kind of communication is performed at the time of remote operation, and system simplification is required in order to carry out this communication reliably.

The display control section 15 has a display control circuit, and carries out display control for the display 29. The display control section 15 may output image data, that is appended with time and date and coordinate information, from the storage section 17 to the communication section 18 by means of the image processing section 14 and the storage control section 16, when it has been determined by the communication determination section 13 that transmission of image data that has been stored in the storage section 17 has been requested. This image data may be transmitted from the communication section 18 to the operation section 20.

The position control section 12 has a CPU (Central Processing Unit), DSP (Digital Signal Processor) and peripheral circuitry, and carries out control within the camera 10 in accordance with a program that has been stored in the storage section 17. The position control section 12 also has a position control circuit etc., and controls movement of the camera 10 by the Y actuator 31a and the X actuator 31b, by means of the movement control section 30, when it has been determined by the communication determination section 13 that movement of the camera 10 has been requested. This position control section 12 functions as a condition changing section, as part of a controller, that changes shooting conditions of the imaging device.

The movement control section 30 has a movement control circuit etc., and carries out control of the Y actuator 31a and the X actuator 31b in accordance with instruction from the position control section 12, to move the camera 10 in the X direction and the Y direction. At the time of this movement, the communication determination section 13 and the position control section 12 move the camera 10 in accordance with a movement pattern that has been stored in the movement pattern 17a of the storage section 17, and also carry out imaging using the imaging section 11 and storage of image data.

Specifically, if a commencement condition 1, such as time, is satisfied then the camera 10 commences operation in order to carry out imaging. First, there is movement to a position (X1, Y1) that has been stored at sequence number 1, and imaging is performed with shooting conditions 1 (aperture, shutter speed, ISO sensitivity etc.). If imaging has been carried out at sequence number 1, next sequential imaging is carried out at sequence number 2, sequence number 3, . . . , sequence number n, and image data at that time is sequentially stored in the storage section 17. Once imaging has been carried out in accordance with movement pattern 17a1, imaging is next carried out in accordance with movement pattern 17a2, . . . .

It should be noted that with this embodiment the movement control section 30 is provided externally to the camera section 10, but this is not limiting, and a movement control section 12b may also be provided within the camera 10. In this case, the movement control section 12b carries out drive control for the Y actuator 31a and the X actuator 31b. Also, while, with this embodiment, drive control is carried out on two axes, namely the X axis and the Y axis that is orthogonal to the x-axis, this is not limiting, and drive control may be carried out for only one axis, and other drive control may also be carried out, such as control on r and θ axes, namely control in two directions of a radial direction and a circumferential direction.

Next, operation of the imaging unit 1 will be described using the flowchart shown in FIG. 9. This flowchart is executed by the CPU within the position control section 12 controlling each of the sections within the imaging unit 1 in accordance with program code that is stored within the storage section 17. It should be noted that with this embodiment the program code is executed by the CPU within the position control section 12, but this is not limiting, and the code may also be executed by a CPU provided in another section, and further is not limited to a CPU being provided in a single section and CPUs may be provided in a plurality of sections and the code executed by these CPUs working in collaboration.

If the flowchart for imaging section communication shown in FIG. 9 is commenced by a power supply being switched on or the like, first a communication stand by state is entered (S101). Here, commencement of communication from the operation section 20 is awaited. For example, the operation section 20 may be operated in the event that the user provides instruction to the imaging unit 1 that has been arranged inside a chamber that is isolated from the operation section 20, such as an incubator. This step is a state of awaiting receipt of a control signal based on this operation, using wireless communication.

Next, it is determined whether or not power supply on/off communication has been performed (S103). As was described previously, with this embodiment power supply for the imaging unit 1 is supplied using a battery, and so in order to prevent consumption of the power supply batteries it is possible for the user to carry out a power supply on or power supply off instruction from the operation section 20 (for example, S139 in FIG. 10).

If the result of determination in step S103 is that there has been power supply on/off communication, imaging on/off processing is carried out (S105). Here, in the case of power supply on, the communication determination section 13 turns the power supply of the imaging section 11 off, while in the case of power supply off the power supply of the imaging section 11 is turned on. Power supply on/off for each of the other sections may also be carried out in tandem with power supply on/off of the imaging section 11. However, the minimum power supply needed to execute functions for determining instructions from the operation section 20 is supplied. As a result of this power supply control it becomes possible to reduce wasteful energy consumption during cell culturing etc.

If the result of determination in step S103 is not power supply on/off communication, it is determined whether or not various wireless communication information has been acquired (S107). If the user carries out various settings by operating the operation section 20, this setting information is transmitted by wireless communication from the communication section 28 of the operation section 20 (for example, S143 in FIG. 10). Information that is necessary to imaging is also transmitted by wireless communication from the communication section 28. As information that is transmitted here there is, for example, information relating to transmission destination of the image data, conditions for at the time of imaging, various parameters, and measurement conditions for when measuring the specimen 51 etc. In this step it is determined whether or not these settings and information have been received from the communication section 18 within the camera 10.

If the result of determination in step S107 is that various wireless communication information has been acquired, information acquisition, various setting and communication etc. are carried out (S109). In this step various settings within the camera 10 are carried out based on various information and settings that have been acquired by the communication section 18.

Once the information acquisition, various settings and communication etc., have been carried out in step S109, or if the result of determination in step S107 was that various information has not been acquired, it is next determined whether or not a manual position designation has been received S111). There may be cases where the user designates a position during preparations for measurement of the specimen 51 within the container 50, or during measurement itself, and wishes to observe images at that position. In such a case the user can designate imaging position by operating the operation section 20 (for example, S147 in FIG. 10). In this step, it is determined whether or not wireless communication for carrying out this manual position designation has been received.

If the result of determination in step S111 is that manual position designation has been received, alignment is carried out (S113). Here, the position control section 12 outputs control signals to the movement control section 30 so as to cause movement of the camera 10 to the manual position that was received by wireless communication. The movement control section 30 carries out drive control of the Y actuator 31a and the X actuator 31b to move the camera 10 to the manual position that has been designated.

If alignment setting has been carried out in step S113, or if it has been determined in step S111 that manual position designation has not been received, it is next determined whether or not an image request has been received (S115). There may be cases where the user, while preparing for measurement or during measurement, wishes to observe images at the manual position that has been designated. In such situations the operation section 20 is operated to transmit an image request. There may also be cases where, during measurement, the user wishes to confirm images and representative images that have been captured so far, and in this type of situation also an image request is transmitted by operating the operation section 20. In this step, therefore, it is determined whether or not an image request signal has been received from the operation section 20.

If the result of determination in step S115 is that there is an image request signal, an image is acquired and wireless communication is carried out (S117). In this case, imaging is performed at the point where alignment was carried out in step S113, and that image is transmitted to the operation section 20. Also, in a case where, during measurement, there has been a transmission request for images that have been taken so far, measurement images of the storage section 17 are read out and transmitted to the operation section 20. Also, if there is a transmission request for representative images that have been selected or composed up to now, during measurement, the representative images 17f are read out from the storage section 17 and transmitted to the operation section 20. It should be noted that in step S109, in the event that a section other than the operation section 20 is designated as the transmission destination for the image data, the image data is transmitted to the designated transmission destination. Also, in a case where images have been transmitted, a transmitted flag is set for the transmitted image data.

If images have been acquired and wireless communication carried out in step S117, or if the result of determination in step S115 is that an image request has not been received, it is next determined whether or not a measurement commencement signal has been received (S119). In the event that the user commences measurement, such as counting the number of specimens 51 within the container 50, the fact that measurement is to be commenced is instructed to the imaging unit 1 by operation of the operation section 20. Here it is determined whether or not a measurement commencement signal to instruct commencement of this measurement has been received. If the result of this determination is that a measurement commencement signal has not been received, processing returns to step S101 and the previous operations are executed.

On the other hand, if the result of determination in step S119 is that a measurement commencement signal has been received, imaging and measurement are commenced (S121). Here, in accordance with an alignment program that has been set and stored, measurement is performed using shooting conditions that have been set, images are stored, and if measurement is interrupted and restarted, the measurement is restarted from the interrupted position. Also, at the time of storage, the representative images are stored together with data having position information. The representative images may be captured when shooting condition are close to representative image conditions, the same as in steps S5 and S7 in FIG. 5, for example, and stored together with data having position information.

In the imaging and measurement of step S121, the camera 10 sequentially carries out imaging in accordance with positions and shooting conditions have been designated by the movement patterns 17a1, 17a2, . . . that have been stored in the storage section 17, and the image data that has been acquired is stored in the memory 17. At the time of storage, various data such as position of the camera 10, time, shooting conditions etc. is appended as tags. This imaging involves a read out step of reading out position of the camera 10 and control data (for example, movement pattern 17a) for controlling imaging conditions at the time of imaging using the camera 10, an imaging step of acquiring image data of a physical object including the specimen 51 using the camera 10, and a position changing step of changing imaging position of the camera 10 based on control data.

In this way, since position and shooting conditions are set in accordance with various control data that has been stored in storage section, at that time it is not necessary for the operation section 20 to carryout frequent communication with the camera 10, and wasteful energy consumption for communication is suppressed. Description has been given here regarding “shooting conditions”, but is also possible to set lighting conditions etc.

Also, the number of specimens 51 is counted and stored by analyzing image data. Counting of the specimens 51 may be carried out by detecting edges and contours within the image data, and using various known procedures such as extracting individual specimens 51. The number of the specimens 51 may be appended as a tag to the image data and stored in the storage section 17.

There may also be cases where measurement is interrupted, such as when a manual position designation is received or when an image request signal is received during measurement (S111, S115). In this type of situation, processing that has been requested is executed, and when restarting the measurement, measurement commences from the interrupted position. Therefore, position when the interrupt occurred, and sequence number for the movement pattern 17a etc. are stored in the storage section 17.

If imaging and measurement have been carried out, it is next determined whether or not the imaging and measurement have been completed (S123). Here, it is determined whether or not imaging and measurement have been completed in accordance with all movement patterns 17a that are stored in the storage section 17. If the result of this determination is that imaging and measurement have not been completed, processing returns to step S107 and the previous operations are executed. In the event that the user operates the operation section 20 during measurement and various settings, designation of manual position or an image request are carried out, processing is executed in accordance with these instructions.

If the result of determination in step S123 is that imaging and measurement are complete, it is determined whether or not there has been transmission (S125). Here it is determined whether or not an image 17c appended with time and date and coordinates that have been stored in the storage section 17 has been transmitted to the operation section 20. Since images that were already transmitted in step S117 would become duplicates, it is determined whether or not there has been transmission for each image, in order to transmit unsent image data. Accordingly, with this embodiment, depending on imaging position and imaging conditions that have been stored in the storage section 17, the communication section 18 will have a time for carrying out communication for positioning and shooting control of the imaging section 11 (may also be for the camera 10) and a time for communication of information that has been acquired by imaging.

If the result of determination in step S125 is that there are images that have not already been transmitted, stored images are subjected to wireless transmission (S127). Here, among the images that were captured in step S121, images that were not transmitted in step S117 are subjected to wireless transmission.

If stored images have been transmitted in step S127, or if the result of determination in step S125 was that there were already transmitted images, processing returns to step S101 and the previously described operations are executed.

In this way, with imaging section communication, shooting for measurement is carried out and selection or composition of a representative image is carried out. Also, in the event that a representative image request has been received from the operation section 20 during measurement (S115) a representative image is transmitted to the operation section 20. As a result, during measurement the user can confirm the representative image, and can easily confirm condition of the specimen even if it is inside an incubator. Further, even when searching measurement data after completion of measurement, if a representative image is used it is possible to easily and rapidly locate the intended measurement data.

Also, with the imaging section communication flow that was shown in FIG. 9, signals corresponding to image data (refer, for example, to S117 and S127), and signals for changing position of the camera 10 (refer, for example, to S113, S115, S119 and S121) are interchanged between the communication section 18 within the imaging unit 1 and the communication section 28 within the operation section 20. In this way, together with exchange of image data, movement control of the camera 10 is carried out using a single communication circuit, and as a result it is possible to simply carry out imaging and measurement of a measured physical object, even if the imaging unit 1 is isolated inside a closed chamber, such as an incubator.

Also, if a measurement commencement signal is received (refer to S119), imaging is carried out at sequential measurement positions in accordance with given sequence numbers, in accordance with a movement pattern 17a that has been stored in the storage section 17. As a result, if a movement pattern is decided upon in advance, it is possible to carry out imaging and measurement automatically. It is also possible to observe a specimen even if imaging is interrupted during measurement (refer, for example, to S111-S115). Further, in the case of an interruption during measurement, measurement is restarted from the interrupted position (refer, for example, to S121).

It should be noted that shooting conditions for visual observation of the specimen 51 within the container 50 by the user (such as aperture, shutter speed, ISO sensitivity), are not necessarily the same as the shooting conditions for measurement (counting) of the specimen 51. It is also to be expected that there may be cases where live view type shooting conditions for visual observation and shooting conditions for storage are different. Shooting may therefore be respectively carried out with a plurality of shooting conditions, to acquire image data. Also, only in a situation where the user has requested images for observation (refer, for example, to S115), shooting may be carried out using shooting conditions for visual observation, and when carrying out shooting for measurement in accordance with the movement pattern 17a shooting may be carried out using shooting conditions for measurement. Also, as shooting conditions, there are shooting conditions corresponding to changes in conditions due to lighting, shooting conditions corresponding to collection conditions and growth conditions of cells, focus conditions that are appropriate for positions of cells etc., and shooting may be carried out under numerous conditions.

Next, operation of the operation section 20 will be described using the information terminal communication flowchart shown in FIG. 10. This flowchart is executed by the control section (CPU etc.) within the operation section 20 controlling each of the sections within the operation section 20 in accordance with program code that is stored within a storage section.

If the flow for information terminal communication is entered, first mode display is carried out (S131). Here the mode of the operation section 20 is displayed on the display 29. For example, if the operation section 20 doubles as a smart phone, there are mobile phone mode, mail mode etc.

Once mode display has been carried out, it is next determined whether or not to launch an examination application (S133). Here it is determined whether or not an application for examining (measuring) to count a number of specimens 51 (hereafter referred to as “examination application”) will be launched. For example, an examination application icon is displayed, and if a touch operation is performed on this icon it is determined that the examination application will be launched. Besides this approach, it may be determined to launch the application if a cursor is moved to select the icon, and it may be determined to launch the application if a dedicated button is operated. If the result of this determination is not to launch the examination application, then other operations are carried out. For example, in the case of a smart phone, mobile phone operations and mail operations are carried out.

If the result of determination in step S133 is to launch the examination application, then a designated camera is accessed (S135). Here access is made to a camera that has been designated using the operation section 20 (the imaging unit 1 with the example in FIG. 7). Specifically, communication is carried out from the communication section 28 of the operation section 20 to the communication section 18 of the imaging unit 1.

Next it is determined whether or not an imaging on/off operation has been carried out (S137). Since the imaging unit 1 is mounted in a sealed chamber such as an incubator to examine the specimen 51 within the container 50, and is supplied with power by power supply batteries, it is possible to instruct power supply on/off for the imaging apparatus from the operation section 20 in order to prevent power supply wastage. Here it is determined whether or not on/off operations for the power supply have been carried out with the operation section 20.

If the result of determination in step S137 is that an imaging on/off operation has been carried out, an on/off signal is transmitted (S139). Here, an imaging on/off signal is transmitted from the communication section 28 of the operation section 20 to the communication section 18 of the camera 10. The camera 10 executes an imaging on/off operation (refer to S105 in FIG. 9) if this signal is received (refer to S103 in FIG. 9).

If the on-off signal has been transmitted in step S139, or if the result of determination in step S137 is that an imaging on/off operation is not carried out, it is next determined whether or not to carry out various settings, such as for image transmission parties, shooting conditions, parameters and measurement conditions etc. (S141). It is possible to designate destinations for transmission of image data that has been captured by the imaging unit 1, various information that is attached to the image data as tags (time and date information, position information, measurement (examination) result information), and representative images. Transmission destination is not limited to the operation section 20, and another information terminal or the like may be designated.

Also, shooting conditions (focus position, aperture value, shutter speed value, ISO sensitivity value, switching of image processing including enhancement of edges, contrast and color etc., and brightness pattern and wavelength of illumination) for when the imaging unit 1 is imaging, and similarly parameters and measurement conditions, may also be set. The movement pattern 17a may also be set to other than a pattern that is stored in the storage section 17 as default. Conditions for selection as a representative image may also be set, and in the event that a representative image is generated by combining a plurality of captured images conditions for such generation may be set. In this step S141, it is determined whether or not an operation has been carried out in order to carry out these various settings.

If the result of determination in step S141 is that operations for various settings have been carried out, various wireless communication information is transmitted (S143). Here, operated information is transmitted from the communication section 28 to the communication section 18 of the camera 10 based on the determination in step S141 (refer to S107 and S109 in FIG. 9).

If various wireless communication information has been transmitted in step S143, or if the result of determination in step S141 was that an operation for various settings was not performed, it is next determined whether or not manual position setting or an image request have been input (S145). As was described previously, if the user designates position of the camera 10 when preparing for measurement or during measurement, and they wish to observe images that have been acquired with the camera 10, it is possible to carry out designation from the operation section 20. There may also be cases where it is desired to confirm a representative image that has been selected or combined up to that point during measurement. In this step, it is determined whether or not these operations have been performed.

It should be noted, regarding position designation of the camera 10, that designation may be by absolute position, such as (x, y) coordinates, and may be designation of movement by relative positional designation in a horizontal direction and vertical direction, while observing an image. Besides this it is also possible to have movement control in accordance with operation amount of a touch panel, switch or dial of the operation section, and to determine a typical observation point and designate movement to that location.

If the result of determination in step S145 is that manual position setting or an image request have been input, designation signals are transmitted (S147). Here signals corresponding to operations in step S145 are transmitted from the communication section 28 to the communication section 18 of the camera 10 (refer to S111-S117 in FIG. 9).

If designation signals have been transmitted in step S143, or if the result of determination in step S145 was that manual position setting or an image request were not input, it is next determined whether or not to carry out a measurement commencement instruction (S149). It is determined whether or not an instruction has been carried out to perform shooting while sequentially moving the camera 10 in accordance with a measurement start instruction by the user, specifically, a movement pattern 17a, and to commence measurement, such as counting of the specimens 51, based on image data that has been captured. An instruction to commence measurement may be carried out by a touch operation or the like on a measurement commencement icon that has been displayed on the display 29 of the operation section 20. Besides this, or at the same time, processing may be carried out at specified time intervals, and processing may be carried out under conditions defined by a specified program.

If the result of determination in step S149 is that there has been a measurement commencement instruction, a commencement signal is transmitted (S151). Here, a measurement commencement signal is transmitted from the communication section 28 to the communication section 18 of the camera 10 (refer to S119 and S121 in FIG. 9).

If a commencement signal has been transmitted in step S151, or if the result of determination in step S149 is that there was not a measurement commencement instruction, it is next determined whether or not measurement results have been received (S153). Here, images acquired using the camera 10 that have been transmitted are displayed on the display 29. It should be noted that in the event that there are many images, it is possible to display only the representative image. Also, the representative image may be displayed at a given size, and a plurality of measurement images may be displayed smaller than the representative image. Display of measurement results of the specimen 51 etc. is also carried out.

If display has been carried out in step S155, or if the result of determination in step S153 was that measurement results were not received, it is determined whether or not to terminate the application (S157). Here it is determined whether or not an instruction to terminate operation of the scanning application, that was launched in step S133, has been issued. If the result of this determination is that the scanning operation is not to be terminated processing returns to step S135, while if the scanning application is to be terminated processing returns to step S131.

In this way, in the information terminal communication flow, if various setting operations to operate the camera 10 are carried out in the operation section 20, signals are transmitted by means of the communication section 28 based on settings in the communication section 18 of the camera 10 (for example, S139, S143, S147 and S151). Also, images that have been acquired by the camera 10 are transmitted from the communication section 18 of the camera 10 to the communication section 28 (for example, S155). In this way, even if the imaging unit 1 is isolated inside a sealed chamber such as an incubator, it is possible to transmit instructions from the operation section 20, and it is possible to receive image data from the imaging unit 1. This means that it is possible to carry out imaging and measurement of a measured physical object simply.

Also, in a case where it is desired to observe a representative image has been observed during measurement, confirmation is possible by transmitting that fact (for example, S145 and S147). Also, selection conditions and combination conditions are set for a representative image (for example, S141), and it is possible to set conditions for a representative image at the camera 10 side (for example, S109 in FIG. 9) by transmitting the set conditions (for example, S143).

It should be noted that with this embodiment, the representative image was obtained when acquiring an image for measurement, similarly to the example shown in FIG. 5. However, this is not limiting, and it is also possible to acquire a representative image after measurement has been completed, as with the example shown in FIG. 4. Also, with this embodiment, regarding the representative image, an image that has good legibility may be generated based on a plurality of image data that have been acquired after shooting a plurality of images.

As has been described above, in each of the embodiments and the modified example, a condition changing section (refer for example, to the controller 21 and position control section 12) that changes imaging conditions of an imaging section (refer, for example, to the imaging section 11), a measurement results storage section that performs measurements based on image data and stores measurement results, and a representative image storage section (refer, for example, to the storage section 17 and the representative images 17f) that selects and stores a representative image from image data, are provided. Also, image data of a physical object is acquired while changing imaging conditions of the imaging section (refer, for example to S11 and S3 in FIG. 4), measurement is performed based on the image data and the measurement results are stored (refer, for example, to S3 in FIG. 4), and a representative image is selected from the image data and stored (refer, for example, to S13 in S15 in FIG. 4).

Also, with each of the embodiments and the modified example, a condition changing section that changes imaging conditions of the imaging section (refer, for example, to the controller 21 and the position control section 12), a measurement section that measures a physical object based on image data (refer, for example, to the image processing section 14), and a representative image generating section that makes an image that has been captured under conditions of good legibility, from among a plurality of image data that have been acquired while changing the imaging conditions using the condition changing section, a representative image and associates this representative image with measurement results from the measurement section (refer, for example to the image processing section 14), are provided. Also, a plurality of image data are acquired while changing imaging conditions of the imaging section (refer, for example, to S3 in FIG. 4), a physical object is measured based on the plurality of image data that have been acquired while changing the imaging conditions (refer, for example, to S11 and S3 in FIG. 4), and an image that has been captured under conditions of good legibility, from among the plurality of image data that have been acquired by the imaging section, is made a representative image and this representative image is associated with measurement results of the physical object (refer, for example, to S13 to S17 in FIG. 4).

With each of the embodiments on the modified example, an image that has been selected from a plurality of image data is made a representative image, but this plurality of images may be images that have been acquired substantially sequentially during continuous shooting, and may be images that have been acquired subsequent to measurement. While there are an imaging section that acquires a plurality of image data of a physical object, and a condition changing section that changes imaging conditions of the imaging section, this shooting condition changing differs for measurement and for a representative image. Also, while measurement of a physical quantity of the physical object is based on at least one item of image data from among the plurality of image data, in the event that the image data for the representative image generation has good legibility for management and retrieval, it may be the same as the data for measurement. It goes without saying that since there are situations where an image having good legibility is subjected to special processing, image data may be different.

In this way, with each of the embodiments and the modified example, since a representative image is generated and associated with measurement results, what type of object the measured physical object is can be intuitively understood, and excellent in retrievable performance from the measurement results. By having the storage section that stores measurement results and images it is possible to create an image file that is excellent from the point of view of searching and management.

It should be noted that while each of the embodiments and the modified example have been described on the assumption that the representative image is a still image, a movie may be generated as a representative image, and also a movie may be captured and a representative image may be selected or combined from within that movie. In this case, a movie thumbnail display may be created together with measurement results. Also, a movie may be captured and a representative image that is a still image may be selected by selecting the most appropriate frame from within the movie.

Also, the present invention is not limited to the camera etc. that has been shown in each of the embodiments and the modified example, and various applications are possible. As the camera, the present invention is also capable of being applied to a camera that is intended for other uses, such as an endoscope camera. In this case, together with capturing an image using an endoscope, various physical quantities are measured and it is possible to store measurement results together with images. The present invention is also capable of being applied to cameras for mounting on Unmanned Aerial Vehicles and self-propelled unmanned vehicles, such as drones. In this case, together with capturing images by moving the Unmanned Aerial Vehicle or self-supporting unmanned vehicle, it is possible to measure various physical properties and store measurement results together with images.

Also, with each of the embodiments on the modified example of the present invention, when storing a plurality of image data legibility is determined, and a representative image is stored based on the results of this determination. This technology can also be applied when carrying out video conferencing with a remote location using the Internet etc. In this case an image having good legibility is determined based on change in images during the conference, for example, change in movement of a character, change in contrast, change in color, change in sound, and content being spoken etc. and this image is stored as a representative image. After completion of the video conference, it is possible to make management easy by searching using the representative image. Also, as the representative image, as was described previously, a plurality of images may be combined or an image may be selected during a conference, or images may be selected or combined after the conference.

In particular, there are many cases where the focus is on conversations between parties in the middle of a video conference, and there may be situations where consciously capturing a representative image during a conference is difficult. For this reason a representative image during a video conference may be automatically captured and determined. This can be achieved, for example, by taking pictures of members who are participating in a video conference, providing a facial recognition section that carries out facial recognition for respective members who are participating in the video conference for two or more images that have been captured at a remote location, providing a characteristic expression determination section that determines whether there are a given number or proportion (including all) of faces among a total number of faces that have been determined using this facial recognition that have a characteristic expression (for example, a smiling face), providing an image combination section that combines or joins two or more images that been captured at a remote location in the event that a given or greater number or proportion of faces have a characteristic expression, and making the combined image the representative image. In this case it is possible to make an image that has two or more members that are remote from each other with a characteristic expression (smiley face) a representative image, and store this representative image.

Also, images may be combined so as to give the impression that members who are participating in the video conference are shaking hands or high-fiving each other.

Also, with each of the embodiments and the modified example, an example has been described where some parts of the overall processing are processed as software by a CPU, and other parts of the overall processing are processed in hardware, but this is not limiting, and it is possible to have all of the processing implemented by carrying out software processing or hardware processing. For example, it is possible to have a hardware structure such as gate circuits generated based on a programming language that is described using Verilog, and also to use a hardware structure that utilizes software such as a DSP (digital signal processor). Suitable combinations of these approaches may also be used.

Also, in each of the embodiments and the modified example, each of the sections are constructed separately, but some or all of these sections may be constituted by software, and executed by a CPU within the controller 21 or position control section 12. Also, some or all of the functions of each section may be implemented using a CPU (Central Processing Unit), peripheral circuits of the CPU and program code, may be implemented by circuits that are executed by program code such as a DSP (Digital Signal Processor), may use a hardware structure such as gate circuits that are generated based on a programming language described using Verilog, or may be executed using hardware circuits.

Also, with the first embodiment, an imaging device has been described using a digital camera, but as a camera it is also possible to use a digital single lens reflex camera or a compact digital camera, or a camera for movie use such as a video camera, and further to have a camera that is incorporated into a mobile phone, a smart phone, a mobile information terminal, personal computer (PC), tablet type computer, game console etc. In any event, it is possible to adopt the present invention as long as a device carries out measurement using image data.

Also, among the technology that has been described in this specification, with respect to control that has been described mainly using flowcharts, there are many instances where setting is possible using programs, and such programs may be held in a storage medium or storage section. The manner of storing the programs in the storage medium or storage section may be to store at the time of manufacture, or by using a distributed storage medium, or they may be downloaded via the Internet.

Also, among the technology that has been described in this specification, with respect to control that has been described mainly using flowcharts, there are many instances where setting is possible using programs, and such programs may be held in a storage medium or storage section. The manner of storing the programs in the storage medium or storage section may be to store at the time of manufacture, or by using a distributed storage medium, or they may be downloaded via the Internet.

Also, regarding the operation flow in the patent claims, the specification and the drawings, for the sake of convenience description has been given using words representing sequence, such as “first” and “next”, but at places where it is not particularly described, this does not mean that implementation must be in this order.

As will be understood by those having ordinary skill in the art, as used in this application, ‘section,’ ‘unit,’ ‘component,’ ‘element,’ ‘module,’ ‘device,’ ‘member,’ ‘mechanism,’ ‘apparatus,’ ‘machine,’ or ‘system’ may be implemented as circuitry, such as integrated circuits, application specific circuits (“ASICs”), field programmable logic arrays (“FPLAs”), etc., and/or software implemented on a processor, such as a microprocessor.

The present invention is not limited to these embodiments, and structural elements may be modified in actual implementation within the scope of the gist of the embodiments. It is also possible to form various inventions by suitably combining the plurality of structural elements disclosed in the above described embodiments. For example, it is possible to omit some of the structural elements shown in the embodiments. It is also possible to suitably combine structural elements from different embodiments.

The present invention is not limited to these embodiments, and structural elements may be modified in actual implementation within the scope of the gist of the embodiments. It is also possible form various inventions by suitably combining the plurality structural elements disclosed in the above described embodiments. For example, it is possible to omit some of the structural elements shown in the embodiments. It is also possible to suitably combine structural elements from different embodiments.

What is claimed is:

1. An imaging apparatus, comprising:
an imaging device that acquires a plurality of image data of a physical object,
a measurement circuit that measures physical quantities of the physical object based on at least one item of image data among the plurality of image data,
a controller that includes a condition changing section that changes imaging conditions of the imaging device, and a representative image determination section that determines a representative image based on image data that has been selected from or combined with the plurality of items of image data, and
a memory that stores measurement results from the measurement circuit and a representative image that has been determined by the representative image determination section.

2. The imaging apparatus of claim 1, wherein:
the memory stores the measurement results and the representative image in association with each other.

3. The imaging apparatus of claim 1, wherein:
the imaging device also acquires a plurality of image data under a plurality of shooting condition that have been changed by the condition changing section, and
the measurement circuit carries out measurement based on a plurality of image data that have been acquired while changing the imaging conditions using the condition changing section.

4. The imaging apparatus of claim 1, wherein:
the representative image determination section makes an image that has been acquired a representative image by imaging by setting imaging conditions for the representative image after the measurement has been carried out.

5. The imaging apparatus of claim 1, wherein:
the representative image determination section selects a representative image from among image data have been acquired, when imaging conditions when the image data was acquired are close to representative image conditions.

6. An imaging apparatus, comprising:
an imaging device that acquires a plurality of image data of a physical object,
a measurement circuit that measures the physical object based on the image data, and
a controller that includes a condition changing section that changes imaging conditions of the imaging device, and a representative image generating section that makes an image, that has been formed under predetermined conditions from among the plurality of image data that have been acquired by the imaging device, a representative image, and associates the representative image with measurement results from the measurement circuit.

7. The imaging apparatus of claim 6, further comprising:
an image processing circuit that applies image processing for measurement to image data that has been acquired by the imaging device, and wherein
the measurement circuit carries out measurement of the physical object using an image that has been subjected to image processing for measurement by the image processing section.

8. The imaging apparatus of claim 6, wherein:
the representative image generating section sets representative image imaging conditions after completion of measurement by the measurement circuit, and the imaging device performs imaging under the representative image imaging conditions.

9. The imaging apparatus of claim 6, wherein:
the representative image generating section stores a taken image as a representative image when imaging conditions at the time of performing measurement using the measurement circuit are close to imaging conditions for a representative image.

10. An imaging method comprising:
acquiring image data of a physical object while changing imaging conditions of an imaging device,
carrying out measurement based on the image data and storing results of this measurement, and
selecting and storing a representative image from the image data.

11. An imaging method comprising:
acquiring image data of a physical object while changing imaging conditions of an imaging device,
measuring the physical object based on a plurality of the image data that have been acquired while changing the imaging conditions, and
making an image, that has been formed under predetermined conditions from among a plurality of image data that have been acquired by the imaging device, a representative image, and associating the representative image with the measurement results of the physical object.
